(19) United States
(12) Patent Application Publication
(10) Pub. No.: US 2015/0075438 A1
(43) Pub. Date: Mar. 19, 2015

(54) Pet Litter Inserts

(71) Applicant: Irene Dorothy Emenecker, Bell, FL (US)

(72) Inventor: Irene Dorothy Emenecker, Bell, FL (US)

(21) Appl. No.: 13/749,200

(22) Filed: Jan. 24, 2013

(51) Int. Cl. A01K 1/01

(52) U.S. Cl. CPC A01K 1/0114
USPC 119/166

(57) ABSTRACT

The insert of the present invention comprises a bottom with slots so it allows the liquid waste to flow through without spreading to the remaining litter. The slots are two different sizes so that various types of litter can be used. With the feature, the liquid waste can be separated from the solid waste, thus it makes the cleaning much easier than using a regular litter pan or box. Since less litter is soiled by the liquid waste, the amount of litter to be replenished every day can be reduced, thus, it can cut down the consumption of litter. As a result, the owner can save money.

### BACKGROUND OF THE INVENTION

1. Field of the Invention

The present invention relates to pet litter pans or boxes, and more particularly to pet litter inserts that can be used with pet litter pans and/or boxes and/or used alone.

2. Description of Related Art

A pet litter pan, also known as pet litter box, is normally provided to small-sized pets for them to excrete indoors. Litter boxes or pans are normally filled with 2-3 inches deep of litter which are typically loose, granular material to absorb moisture or odors from pets' excretion waste.

However, most of the pet litter pans or boxes have a solid base. If non-clumping litter is used, the liquid waste may not be absorbed completely, the liquid waste can stay on the bottom of the litter in the box and makes it soiled and smell. Even if a pet owner uses clumping litter which is the type of litter that can better absorb the liquid waste, the litter after absorbing the liquid waste needs to be selectively scooped out of the litter pan or box and replenished with new litter on a twice or three times a day basis.

Therefore, it is desirable to have a solution to simplify the cleaning and maintenance of the litter pans or boxes and reduce the consumption of the litter in the meantime.

The present invention provides a device to prevent litter from being soiled by the pet's liquid waste so that the frequency for the pet owner to scoop the soiled litter out of the litter pan or box can be reduced and the amount of litter consumed and cost for purchasing litter can be cut down.

### SUMMARY OF THE INVENTION

One object of the present invention is to provide a device that can keep pet litter from being soiled.

Another object of the present invention is to provide a device that separates liquid waste from the solid waste so that the cleaning will be easier.

Yet a further object of the present invention is to provide a device that is more economical to use than using a regular litter pan or box alone.

The insert of the present invention comprises a bottom with slots so it allows the liquid waste to flow through without spreading to the remaining litter. The slots are of two different sizes so that various types of litter can be used. With this unique feature, the liquid waste can be separated from the solid waste, thus it makes the cleaning much easier than using a regular litter pan or box. Since less litter is soiled by the liquid waste, the amount of litter to be replenished every day can be reduced, thus, it can reduce the consumption of litter. As a result, the owner can save money. The insert of the present invention are also designed to adapt to most of the litter pans or boxes available in the market place. It may be used together with some existing litter pans so the pet owners do not need to purchase new litter pans or boxes.

The insert was designed to accommodate large and multiple cats.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a top view of a pet litter insert according to an embodiment of the present invention.

FIG. 2 is an enlarged view of the bottom of the pet litter insert according to the embodiment of FIG. 1.

FIG. 3 is a perspective side view of the pet litter insert according to the embodiment of FIG. 1.

FIG. 4 is a perspective view of the pet litter insert according to the embodiment of FIG. 1 that is placed on the top of a pet litter pan which is indicated in dashed lines.

FIG. 5 is a perspective view of the pet litter insert according to an embodiment of the present invention wherein the insert further comprises a shallow pan for collecting pet's liquid waste that flows through the slots of the bottom in the insert.

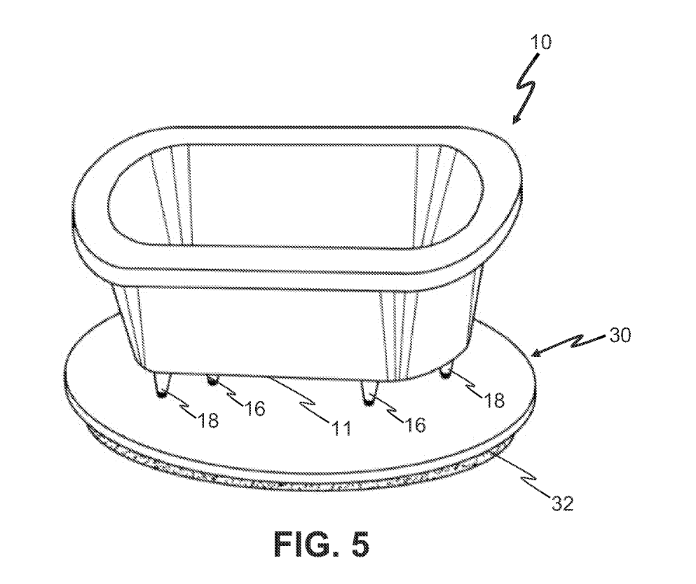

### DESCRIPTION OF THE PREFERRED EMBODIMENT

The pet litter insert of the present invention can be used alone or in combination with the pet litter pan and/or box. In order to be used together with the pet litter pans and/or boxes, the inserts of the present invention are configured to adapt to most of the pet litter pans or boxes available in the market place. The inserts may have different shapes and dimensions. The insert may be designed to accommodate large and multiple cats. The present invention may also be used alone. When it is used alone a piece of absorbing material or a container with a size larger than the bottom of the insert should be placed underneath the insert.

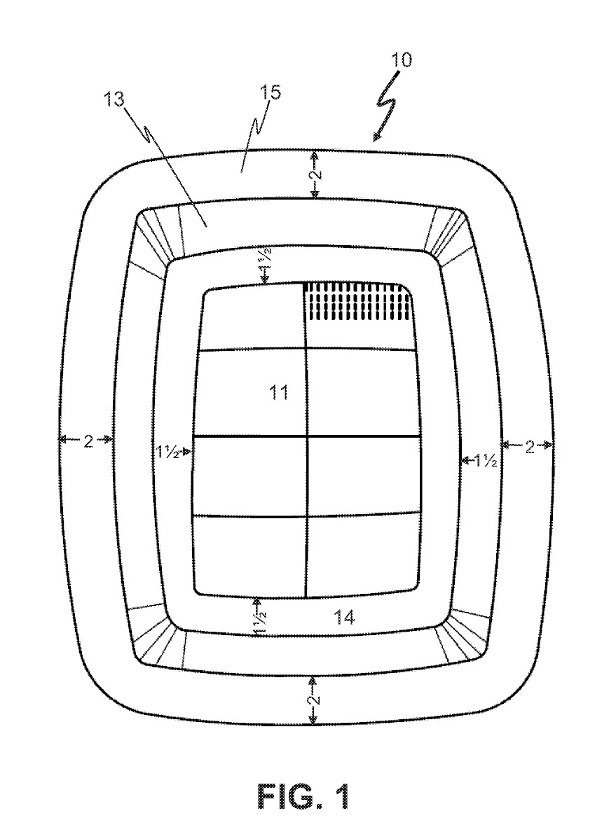

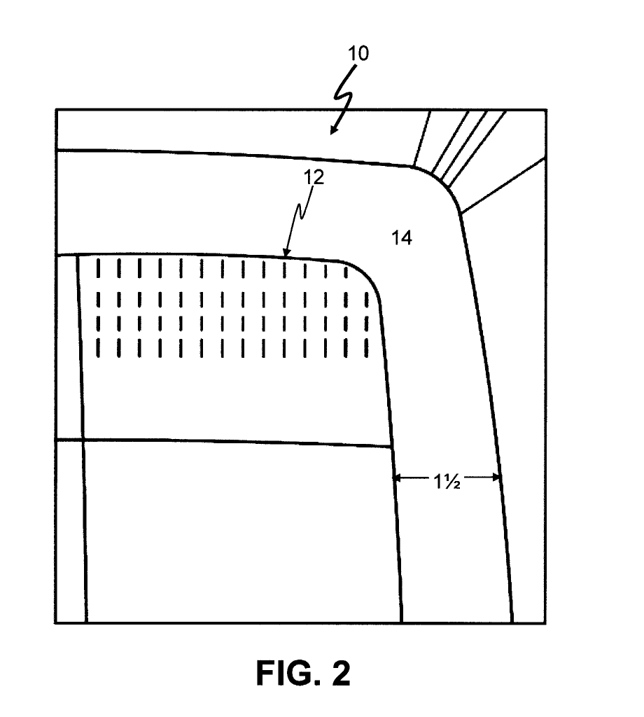

Referring to FIG. 1, there is disclosed a cat's litter pan's insert according to an embodiment of the present invention. The insert 10, which is generally rectangular in shape, comprises a bottom 11 and four inwardly sloped sides 13 integrally connected to the bottom 11 and each other. The bottom 11 has a central area which has a plurality of slots 12 and an outer area 14 that surrounds the central area. The pattern and sizes of slots 12 may be different in different embodiments. As shown in FIG. 2, the preferred embodiment of the insert 10 has two different sizes of slots 12, one with the dimensions of about ⅛ inch wide by ¾ inch long and another with the dimensions of about ⅛ inch wide by ½ inch long so that various types of litter can be used. The two different sized slots 12 are arranged in alternate rows and evenly distributed in the central area of the bottom. The outer area 14 surrounding the central area on the bottom 11 is about one and a half (1.5) inches wide which is solid without any slot so that the bottom 11 is sturdy enough to support the weight of the cat and litter.

The insert 10 may have different dimensions in different embodiment. The preferred embodiment measures about 5 inches deep, about 12-14 inches wide and 15-18 inches long.

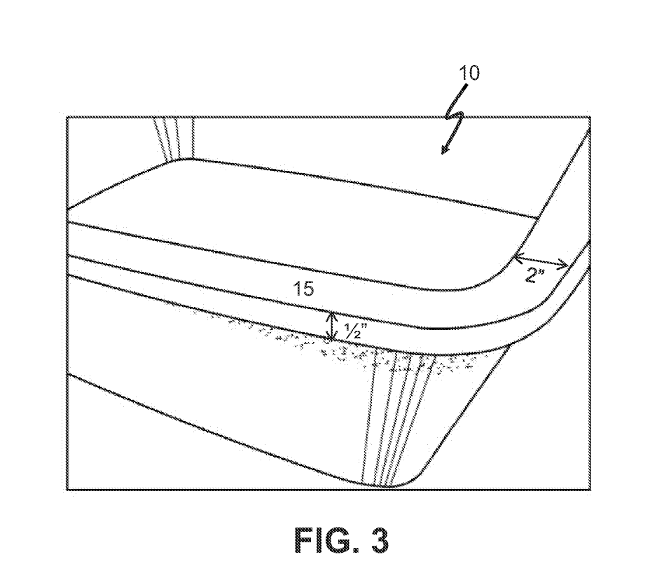

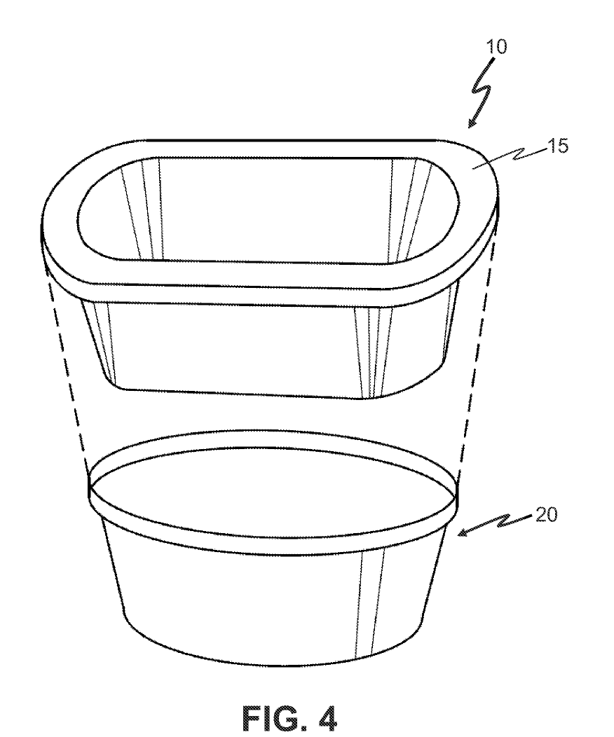

The insert 10 further comprises a lip 15 perpendicularly extending out of the top edge of the sides 13 around the top edge of the insert 10 as shown in both FIGS. 1 and 3. The lip is about two (2) inches wide and a half of an inch (½ inch) deep. The insert 10 may be used with other pet litter pans or boxes. When used with a litter pan or box, the lip 15 is hung on the top edge of the litter pan 20 as shown in FIG. 4. The litter pan 20 is indicated in dashed lines.

As illustrated in FIG. 4, the insert 10 is placed on top of a litter pan 20 or inside a litter box to provide a bottom to support litter and pet(s). As discussed in foregoing sections, because the bottom of most of the litter pan or box is solid, when the pet excretes, the liquid waste may be left on the bottom of the litter box creating unpleasant smell and mess; or even if it is absorbed by the litter, the soiled litter needs to be scooped out of the litter pan and refilled with new litter, creating cleaning and maintenance hassle and costly. Now the insert 10 is placed on top of the pet litter pan, and the litter is placed on the bottom of the insert 10 for pets to excrete. Since the insert 10 has slots on the bottom, when the pet excretes, the slots 12 to the bottom of the litter pan 20 without spreading to the remaining litter on the bottom of the insert 10. Since the bottom of the insert 10 is not in contact with the bottom of the litter pan 20 so that the liquid waste collected on the bottom of the litter pan 20 will not soil the litter in the insert 10. The liquid waste inside the litter pan 20 can be simply dumped to the toilet and flushed with water. The litter pan 20 is easy to clean. Moreover, since the liquid waste is separated from the solid waste, the cleaning is easier. Because the amount of litter getting soiled by the liquid waste is reduced, the litter consumption can be reduced. Thus it is more economical to use a litter pan 20 in combination with the insert 10 of the present invention than use a litter pan 20 alone.

The insert 10 of the present invention may be molded of suitable material, preferable plastic including but not limited to polyethylene and/or polyvinyl chloride.

The insert 10 of the present invention may be used alone. When it is used alone a piece of absorbing material or a container with a size larger than the bottom of the insert should be placed underneath the insert. The insert 10 of the present invention may further comprise a shallow plastic pan 30 to be placed under the bottom of the insert 10 for collecting the liquid waste that flows through the slots on the bottom of the insert 10. The insert 10 may further comprise small legs 16 under and at four corners of the bottom 11 to support the bottom thus the bottom won't directly contact the plastic pan 30 so that the liquid waste can flow through the slots to the pan 30 without spreading to the remaining litter. Both the plastic pan 30 and legs 16 may have a resilient material 32, 18 underneath to provide steadiness. The resilient material 32, 18 includes but is not limited to rubber.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

1. A pet litter insert comprising:
a bottom; and
a plurality of sides integrally connected to the bottom and each other;
a lip perpendicularly extending from the top of the sides surrounding the top of the insert;
wherein the bottom of the insert has a central area which has a plurality of slots and an outer area that surrounds the central area, the slots are narrow enough to allow for pet's liquid waste to flow through the bottom of the insert while retaining litter so that the pet's liquid waste does not soil the litter in the insert, and when the insert is used in conjunction with a litter pan or box the lip is hung on top edges of the litter pan or box to enable the insert to be placed on top of the pet litter pan or box in a way that the bottom of the insert does not contact a bottom of the litter pan or box so that the pet's liquid waste collected in the pet litter pan or box does not soil the litter in the insert.

2. The pet litter insert of claim 1 wherein the slots are of two different sizes so that various types of litter can be used.

3. The pet litter insert of claim 2 wherein one of the slots has dimensions of about ⅛ inch wide by ¾ inch long and the other of the slots has dimensions of about ⅛ inch wide by ½ inch long, the two different sized slots are arranged in alternate rows.

4. The pet litter insert of claim 1 is measured about 12-14 inches wide, 15-18 inches long and 5 inches deep.

5. The pet litter insert of claim 1 has various shapes and dimensions.

6. The pet litter insert of claim 1 wherein the lip is about 2 inches wide and ½ inch deep.

7. The pet litter insert of claim 1 is molded of plastic material.

8. The pet litter insert of claim 1 further comprises a shallow pan for collecting pet's liquid waste that flows through the slots when the insert is used without a pet litter pan or box; and legs to support the bottom of the insert so that the bottom of the insert does not directly contact the shallow pan and thus the litter in the insert would not get soiled by the pet's liquid waste collected in the shallow pan.

9. The pet litter insert of claim 8 further comprises resilient material underneath the legs and the shallow pan to provide steadiness.

10. A pet litter insert comprising:
a bottom; and
a plurality of sides integrally connected to the bottom and each other;
a lip of about 2 inches wide and ½ inch deep perpendicularly extending from the top of the sides surrounding the top of the insert;
wherein the bottom of the insert has a central area which has a plurality of slots and an outer area that surrounds the central area, the slots have two different sizes and are arranged in alternate rows on the bottom allowing for pet's liquid waste to flow through the bottom of the insert while retaining litter so that the pet's liquid waste does not soil the litter in the insert, one of the slots has dimensions of about ⅛ inch wide by ¾ inch long and the other of the slots has dimensions of about ⅛ inch wide by ½ inch long, and when the insert is used in conjunction with a litter pan or box the lip is hung on top edges of the litter pan or box to enable the insert to be placed on top of the pet litter pan or box in a way that the bottom of the insert does not contact a bottom of the litter pan or box so that the pet's liquid waste collected in the pet litter pan or box does not soil the litter in the insert.

11. The pet litter insert of claim 10 is measured about 12-14 inches wide, 15-18 inches long and 5 inches deep.

12. The pet litter insert of claim 10 has various shapes and dimensions.

13. The pet litter insert of claim 10 is molded of plastic material.

14. The pet litter insert of claim 10 further comprises a shallow pan for collecting pet's liquid waste that flows through the slots when the insert is used without a pet litter pan or box; and legs to support the bottom of the insert so that the bottom of the insert does not directly contact the shallow pan and thus the litter in the insert would not get soiled by the pet's liquid waste collected in the shallow pan.

15. The pet litter insert of claim 14 further comprises resilient material underneath the legs and the shallow pan to provide steadiness.
